(19) United States
(12) Patent Application Publication
(10) Pub. No.: US 2020/0252281 A1
(43) Pub. Date: Aug. 6, 2020

(54) SYSTEM PERFORMANCE USING SEMANTIC GRAPH DATA

(71) Applicant: MicroStrategy Incorporated, Vienna, VA (US)

(72) Inventors: Saurabh Abhyankar, McLean, VA (US); Scott Rigney, Arlington, VA (US); Timothy Lang, McLean, VA (US)

(21) Appl. No.: 16/677,183

(22) Filed: Nov. 7, 2019

Related U.S. Application Data
(60) Provisional application No. 62/801,239, filed on Feb. 5, 2019.

(51) Int. Cl. H04L 12/24; G06F 16/21; G06F 16/2455; H04L 12/26; H04L 29/08

(52) U.S. Cl. CPC H04L 41/0816; G06F 16/212; G06F 16/24556; H04L 41/0886; H04L 43/0858; H04L 67/2842; H04L 43/045

(57) ABSTRACT

Methods, systems, and apparatus, including computer programs encoded on computer-readable storage media, for improving system performance using semantic graph data. In some implementations, semantic graph data indicating objects and relationships among the objects is stored. Performance measures for computing operations that access the objects are determined. The performance measures are stored in association with elements of the semantic graph data corresponding to the respective objects accessed. A subset of the performance measures are aggregated based on the semantic graph data. A configuration of one or more computing devices is altered based on the aggregated subset of the performance measures.

### CROSS-REFERENCE TO RELATED APPLICATION

This application claims the benefit of U.S. Provisional Patent Application No. 62/801,239, filed on Feb. 5, 2019, the entirety of which is incorporated by reference herein.

### BACKGROUND

The present specification relates to improving performance of computing devices and systems using semantic graph data.

### SUMMARY

In some implementations, a computing system stores semantic graph data indicating objects and relationships among the objects. The system also stores performance information associated with objects represented in the semantic graph. For example, the performance information can include performance measures indicating latency, task completion time, processor utilization, memory utilization, and so on. These performance measures can be tracked and stored for individual objects and for individual operations or transactions, e.g., for each access to a data object. Using relationships indicated in the semantic graph data, the performance measures can be aggregated in different ways, so that the system can identify which data items, documents, functions, users, devices, server environments, and other items experience performance limitations. The system can use the automatically make changes the configuration of the system to improve performance for the specific areas where performance is identified to be limited.

In one general aspect, a method includes: storing semantic graph data indicating objects and relationships among the objects; generating performance measures for computing operations that access the objects; storing the performance measures in association with elements of the semantic graph data corresponding to the respective objects accessed; aggregating a subset of the performance measures based on the semantic graph data; and altering a configuration of one or more computing devices based on the aggregated subset of the performance measures.

Implementations can include one or more of the following features. For example, in some implementations, aggregating the subset of the performance measures includes aggregating the subset of performance measures by user, by client device, by server, by data object, by data object category, by operation, by operation type, by time period, and/or by geographic location.

In some implementations, the performance measures indicate a latency, a service time, a wait time, a transmission time, a total task completion time, an amount of processor utilization, an amount of memory utilization, a measure of input or output operations, a data storage size, an error, an error rate, a throughput, an availability, a reliability, an efficiency, or a power consumption.

In some implementations, the performance measures include one or more performance measures that are generated and stored for each of multiple individual operations of a client device or server.

In some implementations, altering a configuration of the one or more computing devices includes adding an item to a client device cache, adding an item to a server cache, re-allocating computing resources among users, predictively generating a document, adding available computing capacity, or removing available computing capacity.

In some implementations, altering the configuration includes altering the configuration to increase performance of the one or more computing devices.

In some implementations, altering the configuration includes predictively altering the configuration to avoid an expected decrease in performance of the one or more computing devices.

In some implementations, the method includes determining that a likelihood of usage of a specific data object or class of objects satisfies a threshold; and altering the configuration includes altering the configuration to increase performance for operations involving a specific data object or class of objects.

In some implementations, the specific data object is a specific document or a specific data set.

In some implementations, the method includes determining, based on the aggregated performance measures, a performance limitation for one or more documents or tasks. Altering the configuration includes, in response to determining the performance limitation, altering the configuration of the one or more computing devices to increase performance of the one or more documents or tasks.

Other embodiments of these and other aspects described herein include corresponding systems, apparatus, and computer programs (e.g., encoded on computer-readable storage devices), all of which may be configured to perform the actions of the methods. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for improving system performance using semantic graph data.

FIG. 2 is a diagram showing an illustration of a semantic graph.

FIG. 3 is a table illustrating an example of system performance data.

FIG. 4 is a flow diagram illustrating an example of a process for improving system performance using semantic graph data.

Like reference numbers and designations in the various drawings indicate like elements.

### DETAILED DESCRIPTION

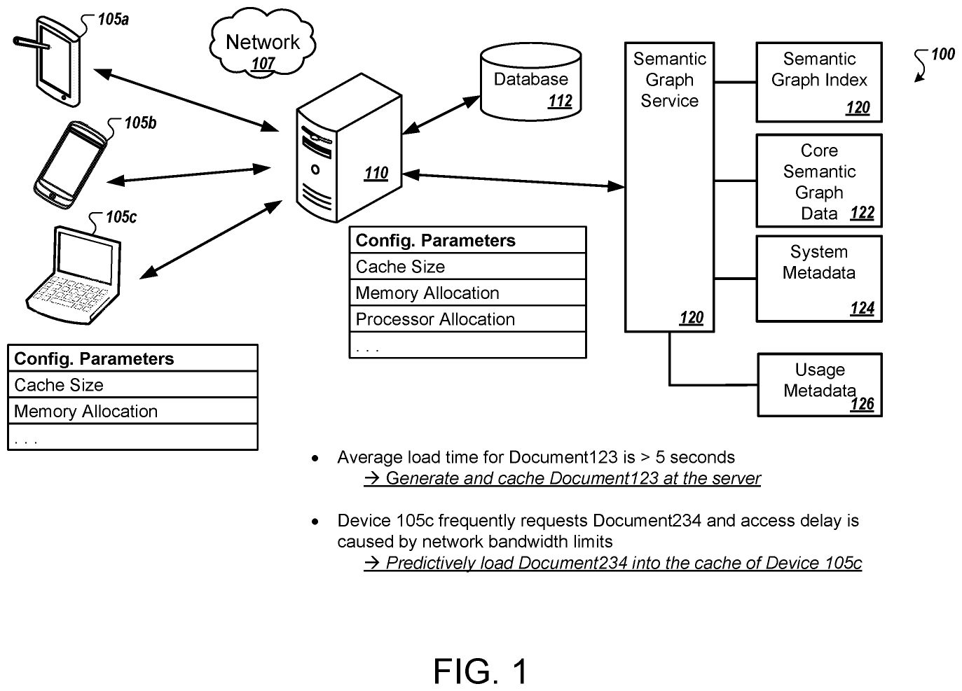

FIG. 1 is a diagram showing an example of a system 100 for improving system performance using semantic graph data.

In general, semantic information can be used by many types of enterprise systems, such as database systems, online analytical processing (OLAP) systems, search engines, and others. Traditionally, semantic data is used to translate database table and other data formats into human-readable forms. Semantic data can provide information about the identity of objects, the meaning of different objects, relationships among objects, and so on. For example, semantic information may indicate that a particular column of data represents a particular attribute or metric and may indicate the data type of the data. Semantic data that indicates the categories or types of objects is useful, but labels and classifications alone typically do not indicate the full scope of the complex interactions, relationships, and histories among objects.

In general, the semantic graph provides an ability to better provide personalized, contextualized information from what otherwise may be a sea of static and flat data without the semantic graph and associated metadata. A semantic graph can indicate enhanced relationships between objects. For example, the semantic graph can include different weights for connections between objects, and the values of the weights can vary dynamically over time. In addition, the semantic graph may indicate multiple different types of connections between objects, as well as specifying directionality of the connections.

The semantic graph and associated metadata can be used to automatically generate personalized recommendations and content to end users, for example, based on the identity of the user and the user's current context. The semantic graph can be used to associate objects with telemetry information, such as usage information that indicates how objects are used, how often objects are used, who the objects are used by, and so on. The relationships modeled with the semantic graph can be varied and complex. Even for only two objects, there may be a multi-dimensional connection between them with different weights representing strengths of different relationships or properties. In this sense, there may be multiple connections between objects representing different types of relationships or different aspects of a relationship (e.g., one weight for co-occurrence frequency in documents, another weight for a degree that one object defines the meaning of the other, another weight for how commonly objects are accessed by the same users, and so on). The weights for the connections dynamically adjusted over time. With this information, applications can better identify which objects out of a large set (e.g., thousands, millions, or more) are most important and most related to each other.

Many different types of objects can be identified and characterized using the semantic graph. For example, objects may represent data sources, data cubes, data tables, data columns, data fields, labels, users, locations, organizations, products, metrics, attributes, documents, visualizations (e.g., charts, graphs, tables, etc.), and many other data items or concepts.

Usage information can be stored for each data object, as well as for each user. The semantic graph may be interpreted differently for each user. For example, the user context (e.g., the identity, permissions, and usage history for the current user) can provide a personalized lens to interpret the data. User information can be used to adjust the weights in the semantic graph to alter search results, recommendations, application behavior, and other aspects of the user's experience.

The semantic graph can also indicate weights for levels of security, access restrictions, and trust for objects. For example, the semantic graph data can indicate the status of certain objects being certified or not, as well as the level of certification and the authority that provided the certification. Certified content is often more useful than content that is not certified, and so application content can give higher weight or higher preference to certified content. In general, the connections and weights for the semantic graph can indicate higher weights for higher-quality content.

The semantic graph provides a framework to integrate various different types of data from different sources, e.g., presence data indicating locations of users, access control data indicating user privileges, real-time application context, user interaction histories, query logs, and so on. Further, the relationships between objects are not limited to a particular use or domain. For example, the usage information and history that is generated from user-submitted search queries and responses can affect the weights between objects used for much more than carrying out searches, e.g., also for personalizing an interface for document authoring, for system performance tuning, for recommending documents, and more.

The semantic graph, through the various associated weights for connections between objects, provides a very useful way for a system to understand the relative weights between objects. In many cases, the meanings of different items and their relative importance is revealed over time through usage information, such as the frequency with which that users use certain objects together in document or a particular visualization. The overall amount of use of different objects (e.g., number of accesses over a period of time) is also a strong signal that can be used to rank objects relative to each other.

As users interact with an enterprise platform, they contribute information and meaning to the semantic graph. As an example, a database may have a column labeled “EFTID,” and the user may know that values in the column represent a unique customer unique ID. The system obtains new information about the meaning of the column as the user interacts with the data, for example, by renaming the column, referencing the data in a visualization, using the data in an aggregation or along an axis, etc. The understanding and context that the user has (e.g., by understanding the meaning of the data) can be at least partially revealed to the system through the user's use of the data over time. The system uses the usage data to capture these indications of meaning and feeds them back into the graph, e.g., through adjusting connections between objects and adjusting weights for connections. A number of contextual cues from user actions can be identified by the system and used to update the semantic graph and optimize the operation of the system.

Information in the semantic graph and associated metadata can be stored on a user-by-user basis and/or at other levels of aggregation (e.g., by user type, by organization, by department, by role, by geographical area, etc.). Usage information is often stored on a per-user basis to indicate the particular actions users take and items viewed. Users can also be grouped together and their respective usage information aggregated. For example, users may have data in the semantic graph indicating their attributes, such as their organization, department, role, geographical area, etc. The system then uses that information to determine the overall usage patterns for a group of users. For example, to determine usage patterns for users in a particular department, the system can identify user objects in the semantic graph that have a connection of a certain type (e.g., a “member of” connection) to the particular department. With this set of users, the system dynamically combines the sets of usage data for the individual users identified. In this manner, the system can aggregate usage logs, system performance data, and other information at any appropriate level as needed.

In the example of FIG. 1, a server system 110 provides analytics functions to various client device 105a-105c. The analytics functions can include serving documents, answering database queries, supporting web applications, generating documents (e.g., reports, dashboards, etc.), and so on. The server system 110 can include one or more computers, some of which may be remotely located or provided using a cloud computing platform. The server system communicates with the client devices 105a-105c through a network 107.

The server system 110 has access to a database 112 that stores data that is used to provide the analytics functions. For example, the database 112 may store documents, data sets (e.g., databases, data cubes, spreadsheets, etc.), templates, and other data used in supporting one or more analytics applications.

The server system 110 stores data for a semantic graph, which can include, among other data, a semantic graph index 120, core semantic graph data 122 (e.g., including object definitions, semantic tags, identifiers for objects and connections, etc.), system metadata 124, and usage metadata 126.

The system may be arranged to provide access to the semantic graph through a semantic graph service 120. For example, the system may provide an application programming interface (API) allowing software modules to look up different information from the semantic graph. The semantic graph and associated metadata can be stored in various formats. As an example, a core set of structured metadata identifying objects and their properties can be stored in a database. Additional associated data can be stored in the same manner or at other locations. For example, a high-speed storage system can store and update usage metadata, system metadata, and other types of information that are constantly being updated to reflect new interactions. This metadata can be associated or linked to the core structured metadata for the objects by referencing objects through the identifiers or other references defined in the core semantic graph structured metadata. The semantic graph service 120 may then provide information to influence various other functions of the enterprise system, such as a search engine, a content recommendation engine, a security or access control engine, and so on. Although the storage of the semantic graph data and associated metadata may be stored at diverse storage locations and across different storage systems, the semantic graph service 120 provides a unified interface for information to be delivered. Thus, the service 120 can provide access to diverse types of data associated with the semantic graph through a single interface. The semantic graph service 120 can provide a consistently available, on-demand interface for applications to access the rich interconnectedness of data in an enterprise system.

As an example, a query response engine can submit a request to the semantic graph service 120 that indicates a certain context. The context information may indicate, for example, user context (e.g., a user identifier), location context (e.g., GPS coordinates or a city of the user), application context (e.g., a document being viewed), or other contextual factors. In some cases, the request indicates one or more context objects (e.g., user objects, location objects, document objects, etc.) and the semantic graph service 120 provides a list of the related objects and scores of how relevant the results are to the context objects. If a recommendation engine submits a request for results of a certain type (e.g., documents, media, etc.) given a certain context, the semantic graph can provide results that identify objects selected based at least in part on the particular usage history and other data associated with the context. The semantic graph service 120 may use both general weights and usage information, e.g., across all users, as well as specific weights and usage information tailored to the context. For example, all using data may be used to define a general weight that is used for a connection in the semantic graph when no specific context is specified. When a user context is specified, the general weight may be adjusted based on user-specific usage data and weightings. Thus the results from the semantic graph service 120 can blend general and context-specific information when appropriate. Of course, if specified in a request or for certain types of requests, responses for a context may be generated using only metadata relating to the context in some implementations.

The semantic graph can be used to automate the adjustment and customization of system processes, e.g., the operating parameters for a server system, a client device, or both. For example, the semantic graph and associated metadata can be used to optimize the performance of an application for different users and different devices. The operating modes and configuration settings of a client and/or server can be adjusted based on the sets of objects that users interact with and the performance measures detected as a result of those interactions. When objects are accessed, performance information can be stored as system metadata linked to the objects represented in the semantic graph. For example, the system metadata can include performance measures for accesses to different objects, with the data being indexed or otherwise associated with the respective identifiers for the objects that are used in the semantic graph. The system metadata characteristics are then used by the system to customize the operating parameters for individual devices, and even for specific objects or functions of an application. The system can store error rates, response times, load levels, and so on at a higher level, e.g., per server, per application, or for an enterprise system as a whole.

As an example, system metadata can indicate which objects take a long time to run, as well as other performance factors (e.g., response time, CPU utilization, memory footprint, object storage size, and so on). Additionally, usage metadata also indicates patterns of usage by users. A system can combine these types of information to alter system parameters to improve performance. For example, the system can use the semantic graph and associated metadata to select specific objects to be cached by a client device or by a server system. Using the semantic graph data, the system can identify objects that are related to a current context of a user (e.g., a frequent topic of interest for the user, a currently open document, a location of the user, etc.). The system metadata indicates performance characteristics for those objects, such as the amount of time needed to retrieve or generate these objects. Usage metadata for the current user can indicate how likely each of the objects are to be accessed. With all of this information, the system determines which objects should be cached. For example, objects having at least a minimum likelihood of being accessed and a retrieval time above a threshold may be cached at a client device. As another example, the system can assign each of the identified objects a score that factors in topical relevance, amount of prior usage, and performance impact. Objects with scores that satisfy a threshold or are ranked in a particular group may be cached to improve performance.

These processes can take into account the unique situation of each user. For example, users may experience different retrieval or execution times for the same object for any number of factors, e.g., due to differing network speeds, different client device types (e.g., tablet, phone, laptop, etc.), different levels of processing capability of the devices, differing amounts of memory of their client devices, differing levels of multitasking, and soon. The system metadata can indicate these differences in performance, tied to specific objects in the semantic graph. Over time, as data is collected, the system metadata can reveal the performance strengths and weaknesses for individual devices and users, with respect to specific objects or object types. For example, a first user may experience a long execution time for an object using a phone, while a second user with a different model of phone or a laptop may experience a very short wait time for execution of the same object. As a result, the system may determine to pre-load or otherwise cache the object for the first user but not for the second user.

The system can take into account performance characteristics in system metadata when the system identifies content for presentation to a user. For example, if the system is identifying search results or content recommendations, two different documents may have generally comparable relevance scores. The system metadata may indicate that the first document would take a minute to generate and the second document is already cached at the server. Based on the performance difference for the two documents, the system can recommend the second document (e.g., cause a user interface element allowing access) instead of the first document. As another example, based on the performance difference the system may rank the second document higher than the first document even if the first document is topically more relevant to the current context of the user.

The system metadata can be generated using performance counters that measure characteristics of various system actions. For example, for a specific action regarding an object, the measures can indicate response time, completion time for the action, CPU utilization attributed to the action, memory utilization for performing the action, an identification of or number of errors encountered, amount of data transferred over a network, and so on.

The system can analyze the system metadata to determine patterns and identify changes in system operation to improve performance. The system metadata can be used to facilitate just-in-time resource availability and allocation. For example, the system may determine that there is a pattern that CPU utilization increases to over 80% at 8:00 am on Monday morning. In response to this detected pattern of high load, the system can automatically activate a new computing node, such as a cloud computing virtual machine, at an earlier time in anticipation of the increased demand, e.g., at 4:00 am on Mondays. The system can also set the new computing node to be deactivated once the high load conditions are over, e.g., at 10:00 am.

Performance metrics can be monitored in real time and as aggregations over certain time periods (e.g., the last 5 minutes, the last hour, etc.). When metrics exceed certain thresholds, indicating that user experience has degraded, the system may change system settings to improve performance.

As another example, the system may have device-based local caches as well as server-based caches. The system metadata may indicate a pattern in which a large number of mobile devices enters a network or increases activity at a certain time or around another contextual factor. The system data indicates not only that there is a group of mobile devices using an application, but also indicates the specific users and devices that are typically used in different scenarios. Based on the metadata indicating the identity of those users and their typical usage patterns, the system can predictively cache the most popular documents or documents predicted to be most relevant on the respective devices. The documents may be additionally or alternatively be cached at the server to improve access also. When users initiate viewing of documents or other content that has been pre-cached, the response can be nearly instant.

With the semantic graph as part of a system-level approach to meeting users' needs, the semantic graph connects usage information, device-specific usage information, presence information, system performance information, and other data sources to enhance the personalization of data and the optimization of system performance. As the user interacts with the system, the interactions can be used as implicit or explicit feedback that feeds back into the connections and weights of the semantic graph.

Various configuration settings can be automatically adjusted using the system metadata, including starting or stopping virtual machines (e.g., spinning up or turning off cloud-computing-based processing nodes) and caching of certain objects. In general, settings can be adjusted based on anticipated demand (e.g., as predicted using usage data), to optimize certain performance measures, e.g., to maximize throughput, minimize dashboard execution type, and so on. Given the performance bottlenecks indicted by the system metadata and the likely accesses determined from usage data, the system can generate documents or other content in advance of a user request and predictively pre-load the content into a server cache or device cache. This can be done on a device-by-device level or a user-by-user level. Predictive actions can also be taken at a greater level of aggregation, for example, at a server to generate and cache a set of the most commonly used documents or documents predicted to be most likely across all users served.

Using the system metadata, the system can re-allocate resources between systems to anticipate or respond to different loads. Another way that allocation is made more effective is with flexible user fencing. Rather than assign the same CPU and memory amount per user, the system can assign dynamically varying allocations based on the usage histories of those users. Different users have different workloads. The semantic graph and system metadata can be used to create a separate resource allocation baseline for each user. The system can then vary the allocations for each user over time, both responsive to observed demand and predictively according to each user's historical usage patterns. At different times and for different types of jobs, the system may allocate different levels of processing capability, memory, and other resources. The allocations may evolve over the course of a day as actual transactions are received or anticipated transactions are predicted.

The semantic graph and system metadata can be used to validate the health and availability of a data source. When system metadata indicates unusual performance measures, the system may act to send alerts or perform other actions in response. For example, the system can monitor the stream of system performance telemetry for many users and devices. If the system detects an outage event for multiple documents that depend on a data source, the system can have an alerting framework to inform other users proactively about the outage for the data source. As another response, the system may initiate diagnostics or testing for the data source, bring an alternate data source online, alert an administrator, mark resources that depend on the data source with a warning, and so on. Similar steps can be used to provide alerts or initiate other actions for outages or performance limitations. For example, if a service is experiencing high load or is responding particularly slowly, the system may notify users whose usage patterns make the most use of the service or mark resources or operations that rely on the service. This can provide more certainty and predictability in a user's experience. The system can also prevent access to functionality determined to be unavailable, for example, restricting a dashboard interface from being opened if a connection to the underlying data source determined to be unavailable due to system performance telemetry received. This can avoid unnecessary use of computing resources at both a client and a server when the system determines that an upstream data source is unavailable and so the operation would not be able to complete.

The semantic graph data can be used to identify links and dependencies among objects and operations, allowing the system to trace performance limitations to a root cause and to attribute performance levels appropriately among various objects and operations that make up larger tasks.

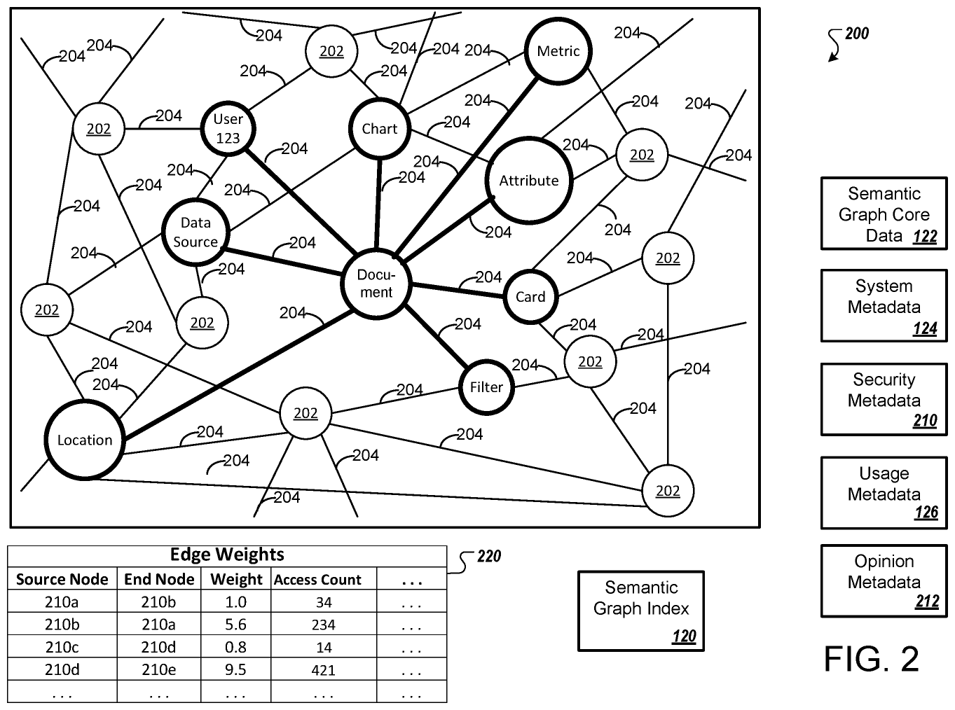

FIG. 2 illustrates an example illustration of a semantic graph 200. Objects are illustrated as nodes 202 and relationships or connections between the objects are illustrated as edges 204. Each node 202 can have a variety of information stored to describe the object it represents, e.g., an object type for the object, a location of the object (e.g., in a file system), an identifier for the object, attributes for the object, etc. The nodes 202 and edges 204 that identify the objects and their connections may be stored in the semantic graph core data 122, along with definitions, semantic tags, and more.

The edges 204 have weights 220 associated with them, e.g., values indicating magnitudes or strengths of the respective connections. Other information indicating the nature or character of the edges 204 can also be stored. Although the illustration only shows one edge 204 between each pair of nodes, there may be multiple different relationships between two objects, which may be represented as, for example, multiple edges 204 with different weights or an edge with multiple dimensions or aspects. In some implementations, an edge 204 and an associated weight represents an overall affinity of objects. In some implementations, Different edges 204 may represent different types of relationships, e.g., dependency (e.g., such as a document requiring data from a data source), co-occurrence, an object being an instance of a class or category, an object being a part of another object, and so on. Edges 204 may be directional. For example, the weight or strength of connection from Object A to Object B may be greater than the weight from Object B to Object A.

The semantic graph 200 has various types of metadata that describe aspects of the objects and connections. The system metadata 124 can indicate the configuration of the system and performance measures. This metadata can be generated and stored for each device or module of an enterprise system, e.g., client devices, content servers, database servers, individual applications, etc. The usage metadata 126 can include records of the accesses made throughout the system to any of the objects represented in the semantic graph 200, as well as the nature or type of access. Security metadata 210 can indicate security policies, permissions and restrictions, histories of security decisions (e.g., to grant or deny access) and so on. The Opinion metadata 212 can indicate explicit or inferred opinions and preferences of users. For example, the opinion metadata 212 can store information about sentiment derived from user actions or user documents, preferences for some items over others, and so on. These types of metadata and others can be associated to identifiers for specific nodes 202 and connections 204, allowing the semantic graph to store information about specific instances of how nodes 202 and connections 204 were accessed.

The system metadata 124, usage metadata 126, and other types of metadata can be log files that show historical information about how an enterprise system operated and how it was used. In some implementations, the metadata is received as real-time or near-real-time telemetry that is measured, logged, and reported as transactions occur. For example, the metadata can collect and store a stream or feed of information from client devices, databases, query processing modules, web servers, and any other component of the enterprise system. Thus, the information can be used to detect performance limitations or emerging trends in usage as they occur and with a very fine-grained level of precision. The telemetry can indicate individual requests, transactions, and operations. In some implementations, some aggregate measures can also be provided, such as an overall load level of a device.

As discussed above, a semantic graph can be a logical layer of software that describes information stored in data systems using human-readable terms and provides metadata that can aid analysis of the data. One of the primary functions is to provide people with way to query databases using common business terms without having to understand the underlying structure of the data model.

A semantic graph can store or have associated with it (i) metadata describing the data in human-understandable terms along with (ii) usage data about how often the data is accessed, by whom, and relationship data about how objects are used together in analysis scenarios. There are a number of objects and metadata that may be stored as part of a semantic graph implementation: data objects, content objects, user objects, usage metadata, security metadata, system metadata, a semantic graph index, opinion metadata, and action objects.

Different vendors often use different terminology for similar concepts. For example, a “dimension” or “attribute” for a data object may both represent the same or similar concept, e.g., a value that represents a property of a data object. Similarly, a “measure” or “metric” in a data set may both refer to the same or similar concept, e.g., a value that provides quantitative indicator, such as a result of a calculation or function.

Data objects in the semantic graph can refer to objects that appear to users as business concepts. For example, “customers”, “products”, “revenue” and “profit” are all common data objects in the semantic graph. A user will typically see those data objects in a user interface and can query the underlying database by interacting with the data objects. For example, a user may query the database by requesting “customers” and “revenue”. The system will then query the database (or in many cases, multiple databases) to fetch the customer revenue data. Querying the system usually requires a number of complex database calls using SQL, MDX or APIs. From a user perspective, however, the complexity of how the data is stored, and the sophisticated query required to retrieve the results are automatically handled on behalf of the user.

Common types of Data objects include dimensions, measures, groups and sets, hierarchical structures, filters and prompts, geographic objects, date and time objects, and synonym objects. Dimensions (Attributes)—Dimensions and Attributes both refer to data that is typically (but not always) a noun, such as “Customer”, “Product”, “Country”, or “Account”. Dimensions can also have additional metadata associated with them to qualify them further. For example, a Dimension object can have further metadata describing it as a Person, which can, in turn, have further metadata describing the Person as being of type Employee.

Measures (Metrics or Key Figures)—Measures and Metrics both refer to data that would typically be used for calculations such as “Revenue”, “Profit”, “Headcount”, and “Account Balance”. Measures can also have additional metadata further describing how the Measure behaves. For example, additional metadata can describe whether bigger values or smaller values are “good” or whether a Measure represents a “currency”.

Groups and Sets—Groups and Sets refer to objects in the semantic graph that represent grouping of data elements. For example, the “Top 10 customers” may be a group that represents the top Customers by some measure (for example Revenue). Groups and Sets can be a simple grouping such as “My Customers=Company 1, Company 2, and Company 3” or a rules-based grouping such as “My Top Customers=top 10 Customers by Revenue for Year=2018”.

Hierarchical structures—Hierarchical structures provide metadata about the relationship between objects and object values in a semantic graph. For example, one such hierarchical structure may describe a Parts hierarchy where certain products are made up of parts.

Filters and Prompts—Filter and prompt objects provide a means to define variables that need to be set either by the programmer, system or end user prior to execution of the object. For example, a semantic graph may have a “Region” filter or prompt whose value must be defined prior to executing the query or content object that it is associated with.

Geographic objects—Geographic objects are objects associated with geographic concepts such as countries, regions, cities, latitude and longitude. Geographic metadata helps the consuming user or system map or perform geospatial calculations using the objects much more easily.

Date and Time objects—Date and Time objects are a special classification of objects that are associated with Dates and Times. This can be used for time based calculations (year over year analysis) or for displaying the object data on Date and Time-based output such as calendars.

Synonym objects—Synonym objects are a special classification of dimension and attribute objects that store alternate values to the values in the dimension objects. This is useful in cases where there are multiple common terms that are used to map to a specific value in the database. For example, in common usage, Coke and Coca-Cola are often used interchangeably when searching for information. The Synonym object stores such alternate values and maps them to a common value in the database.

Content objects in the semantic graph refer to content that is typically displayed to end users as an assembly of data objects. Content objects include:

Reports—Report objects are highly formatted, sectioned and paginated output such as invoices, multi-page tables and visualizations.

Dashboards—Dashboards objects are similar to Report objects in that they also display data and have formatting and visualizations. Dashboards differ from Reports in that they tend have summary data and key performance indicators instead of detailed pages of information.

Tables and Grids—Tables and grids represent data in tabular format (with rows and columns). Tables and grid often are included in Reports and Dashboards.

Visualizations—Visualization objects illustrate data in charts such as bar, pie and line charts.

Cards—Card objects store the key information for a specific topic and are built to augment and overlay third party applications with analytic information in the context of the user.

User objects are people, groups and organizations that are represented in the semantic graph. These objects represent user accounts and groups of user accounts and are used to provide system access, security and rights to other objects in a semantic graph. Users are particularly important in the semantic graph because they are the actors in the system that create, interact with, and use the other objects in the semantic graph. A semantic graph provides an understanding of the relationship between users and the objects in the semantic graph as well as the relationships between the users themselves.

Usage metadata is information stored in a semantic graph about the usage of the objects in a semantic graph. This additional usage data provides information about which objects are used by which users, which objects are used together and which objects are the most and least popular in the system. Usage metadata also contains the context of the user when she interacted with the system. For example, what type of device she was using, where she was, and what data context she was in. This usage metadata, in addition to the other metadata in a semantic graph, provides a means to find relevant information for different users and usage context. Usage metadata is the primary differentiator between a semantic layer and a semantic graph. While a semantic layer primarily describes data in business terms and provides relationship information between the objects as a means to map these business terms to database queries, a semantic graph stores usage information to provide additional information about the weight of the relationships between objects in the semantic graph. Usage metadata can also contain information about when and where objects are accessed.

Security metadata is information stored in a semantic graph about which users have access to which objects, which privileges they have on the objects, and which data they have access to. The Security metadata can also contain special concepts such as whether the objects are certified, contain personally identifiable information or contain sensitive information.

System metadata is data about how the objects in the system perform. This can include system information such as error rates and run times for the objects. This information can be used by users and system processes to optimize performance of the system. For example, the system can automatically notify content authors if their content is experiencing slow load times or high error rates. The system can also use the system metadata in the semantic graph to automatically perform maintenance to improve performance of content. For example, if a content object has slow performance and there are many users that access that content on a predictable basis, the system could potentially automatically schedule execution of the content and cache the results so as to provide users with improved performance.

A semantic graph index indexes key values in the semantic graph so as to provide fast search and retrieval times. These key values may be a variety of types of information, such as keywords, semantic tags, object or node identifiers, connection or edge identifiers, and so on.

Opinion metadata is opinion information about the objects in a semantic graph that is provided by the end users. For example, users could give a ‘thumbs up’ or ‘favorite’ content to indicate that they like or find it useful. Other mechanisms such as a star system or commentary can also be employed as means of storing opinion metadata in a semantic graph. Opinion metadata is useful alongside usage metadata and affinity between objects to help find content that is both relevant to the user's context and of value based on opinion.

Action objects describe actions that can be taken on other objects in a semantic graph. For example, there may be an Action object that takes a Date and Time object and converts it from one format (24 hour) to another (12 hour).

A semantic graph can provide a number of benefits. For example, a primary goal of the semantic graph is to make access to complex business data systems easy for people without database or programming skills. The semantic graph can provide common naming and semantics to represent complex data models with otherwise obscure or non-human-readable names. The semantic graph can provide or support various services built atop it (for example, search or machine-learning-driven recommendation services) with metadata, relationships, and user-based context information that can help answer user questions and recommend the most relevant content to users. The semantic graph can include (or have associated with it) security and audit information to help secure data assets based on user security access profiles.

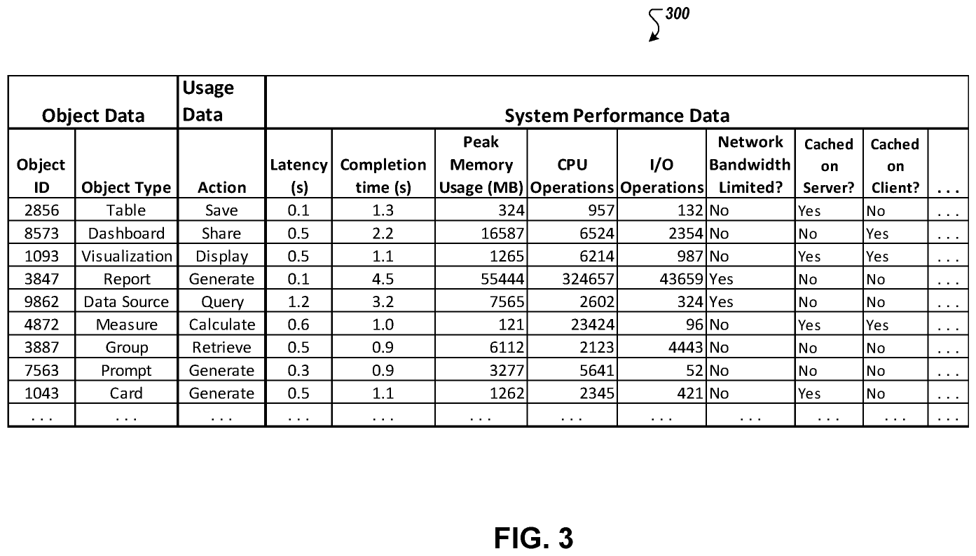

FIG. 3 is a table 300 illustrating an example of system performance data. The example shows records of individual actions or transactions within an enterprise system. Each row represents an instance in which an object was used. Usage data indicates the context and nature of the use, such as the type of action performed. Other types of usage data can also be stored, such as the time of day, the location of a user initiating the action, an identification of the particular client device associated with the action, an indication of the type or capabilities of the client device, an indication of the application being used, an identification of an open document, etc.

The system performance data provides a variety of performance measures for each action represented in the table 300. Among other types of performance measures, the data can indicate latency of the system in responding, completion time for the task, peak memory usage, a measure of memory usage, a measure of CPU operations, a measure of I/O operations, whether the action was limited by network bandwidth, whether the object was cached on the server, whether the document was cached on the client device, and so on. The entries in the table 300 can represent real-time or near-real-time telemetry from servers, client devices, and other components of an enterprise system.

With performance data such as the kind shown in the table 300, an enterprise system can aggregate the data in various ways, and then use the aggregated data to detect, predict, and remove performance limitations in the system. For example, to assess the performance needs for a user to retrieve a document, the system can use the semantic graph data to identify all connected objects that the document depends on to run. Then, for each of the identified objects, the system can then aggregate the performance measures for accessing the object. This can include a weighted combination of measures, for example, one that weights more highly the performance measures for the current user but still takes into account performance measures experienced by other users. The weighting can take into account the similarity between the current context and action of the current user and the context and action that the other performance measures correspond to, with higher similarity resulting in higher influence in the combination. In addition, the weighted combination can also include components reflecting performance of other similar objects and actions, such as an aggregation of performance measures among other objects of the same type or other objects hosted by the same server.

With aggregated performance measures (e.g., mean, mode, maximum, minimum, etc.) the system can compare the measures to certain thresholds. These can be static or predetermined thresholds (e.g., whether task completion took longer than 3 seconds) or can be dynamically set (e.g., whether task completion took longer than the average for this document type for actions over the last hour). By comparing different aggregated measures with corresponding threshold values, the system can identify performance bottlenecks, in response to new actions, after actions complete, and predictively in advance of anticipated actions. The system can store data that maps different types of performance limitations to different corrective actions. For example, a long document generation time for a computationally intensive action (e.g., generating a large report) may be mapped to the corrective action of storing a cached copy at a server. Similarly, a long response latency experience by a client may be mapped to a corrective action of re-assigning the user to a server with a lower load, starting an additional cloud-computing-based virtual machine to increase capacity, or reallocate the priority of tasks at a server. In this manner, the system can automatically identify changes to a system configuration to improve performance and can automatically carry out those actions to improve performance of the system.

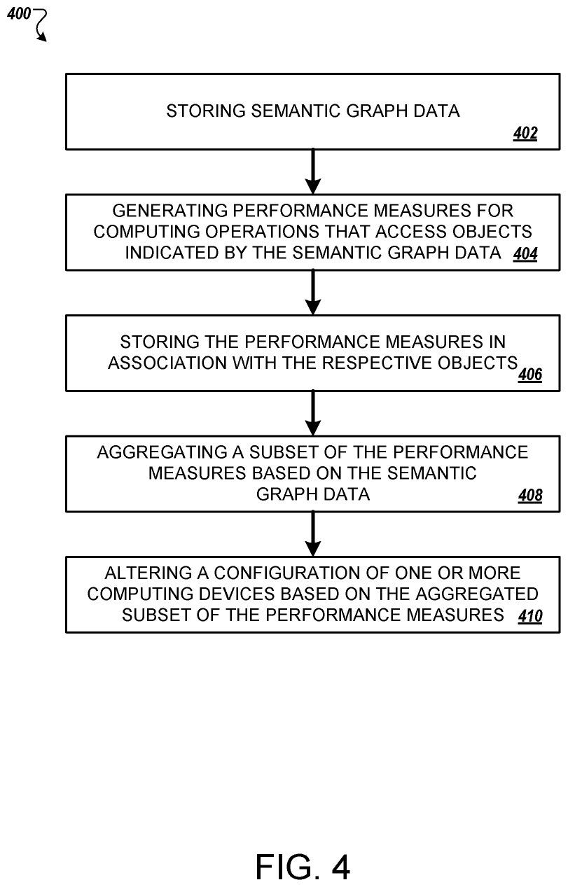

FIG. 4 is a flow diagram illustrating an example of a process 400 for improving system performance using semantic graph data. The process 400 may be used to identify performance limitations and automatically correct them. Similarly, the process 400 may be used by a system to gradually and incrementally adjust system configuration to respond to or even predict changes in loads and circumstances of the system. For example, the configuration changes can be made to maintain a desired level of performance over varying conditions.

One or more computers store semantic graph data indicating objects and relationships among the objects (402). As discussed above, the semantic graph data may indicate relationships through connections and connection weights between nodes representing objects. The one or more computers can be configured to use the semantic graph data for various purposes, such as to respond to user requests, to retrieve content for presentation, to provide recommended content, to provide semantic interpretation, and more. For example, the one or more computers can be configured to monitor and track device interactions and data access, so that the use of objects (e.g., data elements, data sets, applications, and so on) are linked to the nodes in the semantic graph that corresponding to the objects accessed.

The one or more computers generate performance measures for computing operations that access the objects (404). The performance measures can indicate at least one of a latency, a service time, a wait time, a transmission time, a total task completion time, an amount of processor utilization, an amount of memory utilization, a measure of input or output operations, a data storage size, an error indication or number of errors, an error rate, a throughput, an availability, a reliability, an efficiency, and/or a power consumption.

In some implementations, the performance measures can include one or more performance measures that are generated and stored for each of multiple individual operations of a client device or server. For example, a set of performance measures (e.g., a memory usage, a number of input/output operations, an amount of CPU operations, a response time, etc.) can be determined for each computing action or transaction. Examples of these actions include a document being requested and served, a query being submitted and processed, an object being retrieved, a function being evaluated, and a visualization being generated. This can provide a rich set of data about how individual data elements, resources, functions, applications, and devices are performing. For example, for documents served by a server, performance measures can be stored for each document, and for each instance of users requesting the document. Similarly, performance measures for the processing of each of multiple different queries can be determined.

The one or more computers store the performance measures in association with elements of the semantic graph data corresponding to the respective objects accessed (406). For example, performance measures involving an object are associated with the node and/or connections in the semantic graph for the object. If a user device retrieves a document, performance measures (e.g., throughput, response time, etc.) for the document retrieval can be stored in association with an object identifier for the document that was retrieved. The performance measures may also be associated with object identifiers for the server that provided the document, the user device that requested it, network elements that forwarded the document, the application that rendered or presented the document and so on. These stored associations with semantic graph elements (e.g., nodes and/or connections) can enable the one or more computers to efficiently use the large volume of data that is generated in an enterprise system having many servers, devices, and so on.

The one or more computers aggregate a subset of the performance measures based on the semantic graph data (408). The performance measures can be aggregated according to any of various different factors or dimensions. For example, a subset of performance measures can be aggregated by user, by user group, by role, by department, by organization, by authentication level or privilege level, by client device, by server, by data object, by data object category, by operation, by operation type, by time period, and/or by geographic location. Aggregations can be made over combinations of these factors. As just a few examples, an aggregation may be performed for a specific user and application, for specific types of objects and specific devices (e.g., dashboards provided by a specific server), or for all client devices in a geographical area.

As an example, the one or more computers can aggregate the performance measures for actions over a time period (e.g., an hour, a day, a week, etc.) for a particular client device. The one or more computers can use this subset of performance data to determine the overall performance of the client device and determine whether to automatically adjust its configuration.

As another example, the one or more computers can aggregate performance measures for a particular document, using the semantic graph data to identify the subset of performance measures that are associated with the object identifier for the document. This can show an overall view of how that document performs across different client devices, servers, applications, locations, and so on.

In some implementations, the one or more computers use connections (e.g., edges) between nodes in the semantic graph to carry out the aggregation. For example, the one or more computers may aggregate the subset of performance measures for a category of document, such as a dashboard. Based on a dashboard document type object, the one or more computers can use connections to other document objects, and so identify all objects of the dashboard type, and then select performance measures for all documents connected to the dashboard document type object. As another option, nodes for objects may declare or otherwise indicate their type (e.g., with an object type identifier or code), and the one or more computers can identify the set of nodes having the dashboard type identifier and then aggregate the performance information for the identified set of nodes.

In determining the aggregations, the one or more computers may identify or select portions of the overall set of tracked performance data, e.g., portions that involve less than all of the available data. The aggregation may involve, but does not require, performing a function on the subset of records, e.g., to determine an average value (e.g., a mean, median, mode, etc.), a maximum value, a minimum value, to combine various performance measures (e.g., in a weighted combination), or to determine a count or total based on the subset.

In some implementations, the data is aggregated according to contextual factors. For example, one or more of time, location, user identity, device identity, or other factors can be used. For example, the one or more computers can aggregate information that occurs in a particular context, which might be defined as, e.g., during business hours at a specific office location.

The one or more computers alter a configuration of one or more computing devices based on the aggregated subset of the performance measures (410). The one or more computers may alter their own configuration or a configuration of another device. As a few examples, altering a configuration may include at least one of adding an item to a client device cache, adding an item to a server cache, re-allocating computing resources among users, re-allocating loads among devices (e.g., servers), predictively generating a document, adding available computing capacity, removing available computing capacity, altering a network topology, or changing software settings. In some implementations, additional instances of software (e.g., containers, virtual machines, application instances, etc.) may be initiated or terminated as part of the configuration changes.

The configuration can be altered to increase performance of the one or more computing devices. Configuration changes can be made to respond to detected decreases in performance, such as the average performance measure for an action falling below a threshold representing an average, recent, or desired level of performance. For example, if a document has normally taken 1.5 seconds to load but now exceeds that typical time by at least a threshold amount (e.g., by more than 50%, or by more than 1 second), the one or more computers may take an action to prioritize loading of the document or to add the document to a cache to improve performance. The one or more computers can store data that maps types of configuration changes to the performance measures they affect. For example, increasing cache size can be designated as an action that decreases document retrieval times and other response times.

As an example, the one or more computers may identify, based on the aggregated performance measures, a performance limitation for one or more documents or tasks. This may be done by comparing one subset of data to another, such as by comparing the average of load times for a specific document (e.g., averaged over multiple load attempts by multiple users) with the average of load times of documents of the same or similar type. The nature of the performance limitation may be determined, which can include determining the scope (e.g., number and type of users and devices affected) and impact (e.g., level of severity, quantified measure, etc.) of the limitation. In response to identifying the performance limitation, the configuration of the one or more computing devices can be altered to increase performance of the one or more documents or tasks. For example, if a high load time is identified for a specific set of users and devices, the one or more computers can select to refresh the cache of those devices, to pre-cache the document locally for those devices, to prioritize requests from those devices, or take other action to decrease the effect of the limitation.

Configuration changes can be made for other reasons besides increasing performance. For example, aggregated data can indicate objects or actions where performance is above typical levels and so resources may be conserved or re-allocated in response. For example, a cache size for one application may be decreased in response to determining that response times for the application are consistently below average, which may allow capacity to increase the cache for a different application with slower response times.

In some implementations, the aggregated performance measures are used to predictively alter the configuration of one or more computing devices. For example, based on aggregated measures to avoid an expected decrease in performance of the one or more computing devices.

The one or more computers can determine that a likelihood of usage of a specific data object or class of objects satisfies a threshold. Configuration changes can then be made to increase performance for operations involving the specific data object or class of objects. The specific data object can be a specific document or a specific data set.

The one or more computers may be configured to periodically and repeatedly measure performance for different aggregations of the performance measures. The analysis may be performed automatically, e.g., continually or on an ongoing basis, or in response to a trigger or condition that the one or more computers detects For each round of analysis, the semantic graph data can be used to aggregate an up-to-date subset of the performance measures for an accurate determination.

For example, the one or more computers may be configured to monitor different aggregations of data. One type of aggregation determined and monitored may be the performance measures for specific individual users, such as executives. Another type of aggregation monitored may be response time for individual servers, with each server having its performance separately aggregated. Another aggregation monitored may be for individual documents or for document types. Performance measures for each of these aggregations may be compared with corresponding baseline or threshold values to determine whether to change a configuration and in what manner to change it (e.g., to what extent or magnitude, among other factors). Similarly, the trends and patterns indicated by the aggregations (e.g., by a progression of an aggregated measure over time) can be used to predictively make changes to the configuration of one or more devices.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method performed by one or more computers, the method comprising:
storing, by the one or more computers, semantic graph data indicating objects and relationships among the objects;
generating, by the one or more computers, performance measures for computing operations that access the objects;
storing, by the one or more computers, the performance measures in association with elements of the semantic graph data corresponding to the respective objects accessed;
aggregating, by the one or more computers, a subset of the performance measures based on the semantic graph data; and
altering, by the one or more computers, a configuration of one or more computing devices based on the aggregated subset of the performance measures.

2. The method of claim 1, wherein aggregating the subset of the performance measures comprises aggregating the subset of performance measures by user, by client device, by server, by data object, by data object category, by operation, by operation type, by time period, and/or by geographic location.

3. The method of claim 1, wherein the performance measures indicate a latency, a service time, a wait time, a transmission time, a total task completion time, an amount of processor utilization, an amount of memory utilization, a measure of input or output operations, a data storage size, an error, an error rate, a throughput, an availability, a reliability, an efficiency, or a power consumption.

4. The method of claim 1, wherein the performance measures include one or more performance measures that are generated and stored for each of multiple individual operations of a client device or server.

5. The method of claim 1, wherein altering a configuration of the one or more computing devices comprises adding an item to a client device cache, adding an item to a server cache, re-allocating computing resources among users, predictively generating a document, adding available computing capacity, or removing available computing capacity.

6. The method of claim 1, wherein altering the configuration comprises altering the configuration to increase performance of the one or more computing devices.

7. The method of claim 1, wherein altering the configuration comprises predictively altering the configuration to avoid an expected decrease in performance of the one or more computing devices.

8. The method of claim 1, further comprising determining that a likelihood of usage of a specific data object or class of objects satisfies a threshold; and
wherein altering the configuration comprises altering the configuration to increase performance for operations involving a specific data object or class of objects.

9. The method of claim 8, wherein the specific data object is a specific document or a specific data set.

10. The method of claim 1, comprising determining, based on the aggregated performance measures, a performance limitation for one or more documents or tasks;
wherein altering the configuration comprises, in response to determining the performance limitation, altering the configuration of the one or more computing devices to increase performance of the one or more documents or tasks.

11. A system comprising:
one or more computers; and
one or more computer-readable media storing instructions that, when executed by the one or more computers, cause the one or more computers to perform operations comprising:
storing, by the one or more computers, semantic graph data indicating objects and relationships among the objects;
generating, by the one or more computers, performance measures for computing operations that access the objects;
storing, by the one or more computers, the performance measures in association with elements of the semantic graph data corresponding to the respective objects accessed;
aggregating, by the one or more computers, a subset of the performance measures based on the semantic graph data; and
altering, by the one or more computers, a configuration of one or more computing devices based on the aggregated subset of the performance measures.

12. The system of claim 11, wherein aggregating the subset of the performance measures comprises aggregating the subset of performance measures by user, by client device, by server, by data object, by data object category, by operation, by operation type, by time period, and/or by geographic location.

13. The system of claim 11, wherein the performance measures indicate a latency, a service time, a wait time, a transmission time, a total task completion time, an amount of processor utilization, an amount of memory utilization, a measure of input or output operations, a data storage size, an error, an error rate, a throughput, an availability, a reliability, an efficiency, or a power consumption.

14. The system of claim 11, wherein the performance measures include one or more performance measures that are generated and stored for each of multiple individual operations of a client device or server.

15. The system of claim 11, wherein altering a configuration of the one or more computing devices comprises adding an item to a client device cache, adding an item to a server cache, re-allocating computing resources among users, predictively generating a document, adding available computing capacity, or removing available computing capacity.

16. The system of claim 11, wherein altering the configuration comprises altering the configuration to increase performance of the one or more computing devices.

17. The system of claim 11, wherein altering the configuration comprises predictively altering the configuration to avoid an expected decrease in performance of the one or more computing devices.

18. The system of claim 11, wherein the operations comprise determining that a likelihood of usage of a specific data object or class of objects satisfies a threshold; and
wherein altering the configuration comprises altering the configuration to increase performance for operations involving a specific data object or class of objects.

19. The system of claim 18, wherein the specific data object is a specific document or a specific data set.

20. One or more computer-readable media storing instructions that, when executed by the one or more computers, cause the one or more computers to perform operations comprising:
storing semantic graph data indicating objects and relationships among the objects;
generating performance measures for computing operations that access the objects;
storing the performance measures in association with elements of the semantic graph data corresponding to the respective objects accessed;
aggregating a subset of the performance measures based on the semantic graph data; and
altering a configuration of one or more computing devices based on the aggregated subset of the performance measures.
